(19) United States
(12) Patent Application Publication
(10) Pub. No.: US 2022/0376720 A1
(43) Pub. Date: Nov. 24, 2022

(54) WIRELESS DEVICE, CONTROL METHOD THEREOF, AND NON-TRANSITORY COMPUTER READABLE MEDIUM STORING CONTROL PROGRAM

(71) Applicant: NEC Corporation, Tokyo (JP)

(72) Inventor: Tatsuya SOMA, Tokyo (JP)

(73) Assignee: NEC Corporation, Tokyo (JP)

(21) Appl. No.: 17/746,051

(22) Filed: May 17, 2022

(30) Foreign Application Priority Data
May 19, 2021 (JP) 2021-084779

(51) Int. Cl. H04B 1/04

(52) U.S. Cl. CPC H04B 1/0475; H04B 1/0458; H04B 2001/0425; H04B 2001/0433

(57) ABSTRACT

A wireless device includes a distortion compensation unit that imparts a distortion compensation component to a radio signal and outputs the radio signal, an amplifier that amplifies the radio signal to which the distortion compensation component is imparted by the distortion compensation unit, and a signal-to-noise-ratio adjustment unit that deteriorates a signal to noise ratio of an output signal of the amplifier and outputs the output signal as a feedback signal, in which the distortion compensation unit estimates, from the feedback signal, a distortion component contained in the output signal of the amplifier and imparts the distortion compensation component having an inverse characteristic of the estimated distortion component to the radio signal.

### INCORPORATION BY REFERENCE

This application is based upon and claims the benefit of priority from Japanese patent application No. 2021-084779, filed on May 19, 2021, the disclosure of which is incorporated herein in its entirety by reference.

### TECHNICAL FIELD

The present disclosure relates to a wireless device, a control method thereof, and a non-transitory computer readable medium storing a control program.

### BACKGROUND ART

Millimeter-wave and microwave communication devices use a distortion compensation technology called Digital Pre-distortion (DPD) in order to improve the linearity of output signals of analog transmission circuits. In DPD, a nonlinear response characteristic of an analog transmission circuit is modeled by a polynomial function, and an inverse characteristic of distortion obtained from the model is imparted to an input signal to the analog transmission circuit. For model estimation, a method using a ridge regression method is known. The ridge regression method is a method of using a cost function obtained by adding a regularization term according to the coefficient of a polynomial to the sum of squares of the residual in a least-squares method to determine the coefficient of the polynomial that minimizes the cost function (see Japanese Unexamined Patent Application Publication No. 2010-273214).

The procedure for calculating the parameter of a model by minimizing the cost function in the ridge regression method is known to be equivalent to the procedure for calculating the parameter of a model in maximum likelihood estimation, assuming that input data has uncertainty that follows Gaussian distribution. In this case, it is known that the coefficient of the regularization term of the cost function of ridge regression can be interpreted as a value proportional to the dispersion of Gaussian distribution, which is a prior distribution (see Pattern Recognition and Machine Learning, Christopher M. Bishop, Springer, ISBN-13: 978-0387-31073-2, pp. 28-30).

Besides, Japanese Unexamined Patent Application Publication No. 2018-78532 discloses a base station including a plurality of transmission units that transmits a distortion-compensated transmission signal, in which each transmission unit includes a first amplifier that amplifies and outputs the transmission signal, a feedback path that attenuates an output of the first amplifier and feeds back a signal of the attenuated output, and a distortion compensating unit that performs distortion compensation based on a distortion compensation coefficient calculated based on the signal fed back via the feedback path.

In the related arts such as Japanese Unexamined Patent Application Publication No. 2010-273214, and Pattern Recognition and Machine Learning, Christopher M. Bishop, Springer, ISBN-13: 978-0387-31073-2, pp. 28-30, in order to obtain a more valid model when a distortion model of an amplifier is estimated, a regularization term is added to an evaluation function as a part of digital signal processing. However, the related arts have a problem that a parameter corresponding to the regularization term cannot be appropriately set unless a person is familiar with the digital signal processing. That is, the related arts still have a problem that the linearity of an output signal (radio signal) of a communication device cannot be improved.

### SUMMARY

A purpose of the present disclosure is to provide a wireless device, a control method thereof, and a control program that solve the above problem.

A wireless device according to an example embodiment includes a distortion compensation unit that imparts a distortion compensation component to a radio signal and outputs the radio signal, an amplifier that amplifies the radio signal to which the distortion compensation component is imparted by the distortion compensation unit, and a signal-to-noise-ratio adjustment unit that deteriorates a signal to noise ratio of an output signal of the amplifier and outputs the output signal as a feedback signal, in which the distortion compensation unit estimates, from the feedback signal, a distortion component contained in the output signal of the amplifier and imparts the distortion compensation component having an inverse characteristic of the estimated distortion component to the radio signal.

A control method of a wireless device according to an example embodiment includes a distortion compensation step of imparting a distortion compensation component to a radio signal and outputting the radio signal, an amplification step of amplifying, by an amplifier, the radio signal to which the distortion compensation component is imparted, and a signal-to-noise-ratio adjustment step of deteriorating a signal to noise ratio of an output signal of the amplifier and outputting the output signal as a feedback signal, in which the distortion compensation step includes estimating, from the feedback signal, a distortion component contained in the output signal of the amplifier and imparting the distortion compensation component having an inverse characteristic of the estimated distortion component to the radio signal.

A control program according to an example embodiment causes a computer to execute a distortion compensation process of imparting a distortion compensation component to a radio signal and outputting the radio signal, an amplification process of amplifying, by an amplifier, the radio signal to which the distortion compensation component is imparted, and a signal-to-noise-ratio adjustment process of deteriorating a signal to noise ratio of an output signal of the amplifier and outputting the output signal as a feedback signal, in which the distortion compensation process includes estimating, from the feedback signal, a distortion component contained in the output signal of the amplifier and imparting the distortion compensation component having an inverse characteristic of the estimated distortion component to the radio signal.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram showing a configuration example of a wireless device according to a first example embodiment;

FIG. 2 is a block diagram showing a first specific configuration example of a signal-to-noise-ratio adjustment unit provided to the wireless device shown in FIG. 1;

FIG. 3 is a block diagram showing a second specific configuration example of the signal-to-noise-ratio adjustment unit provided to the wireless device shown in FIG. 1;

FIG. 4 is a block diagram showing a third specific configuration example of the signal-to-noise-ratio adjustment unit provided to the wireless device shown in FIG. 1;

FIG. 5 is a block diagram showing a fourth specific configuration example of the signal-to-noise-ratio adjustment unit provided to the wireless device shown in FIG. 1;

FIG. 6 is a block diagram showing a configuration example of a wireless device according to a second example embodiment; and

FIG. 7 is a block diagram showing a configuration example of a wireless device according to a third example embodiment.

### EXAMPLE EMBODIMENTS

Hereinafter, example embodiments are described with reference to the drawings. Note that, the drawings are simplified, and the technical scope of the example embodiments should not be narrowly interpreted based on the drawings. The same components are denoted by the same reference signs, and repeated explanations thereof are omitted.

The present disclosure will be described below in separate sections or example embodiments as needed. However, they are not unrelated to each other unless otherwise explicitly specified, and one of them is a modification, an application, detailed explanation, or supplementary explanation of a part or all of the other. Furthermore, when the number or the like (including the number of pieces, a numerical value, an amount, and a range) of components is referred to in the following example embodiments, the number or the like is not limited to a specific number but may be more than or less than the specific number unless otherwise explicitly specified or unless obviously limited to the specific number in principle.

Furthermore, the components (including operation steps) in the following example embodiments are not necessarily essential unless otherwise explicitly specified or unless obviously necessary in principle. Similarly, when a shape, a positional relation, or the like of the components is referred to in the following example embodiments, what is approximate to or similar to the shape or the like is substantially included unless otherwise explicitly specified or unless obviously not applicable in principle. This similarly applies to the above number or the like (including the number of pieces, a numerical value, an amount, and a range).

### First Example Embodiment

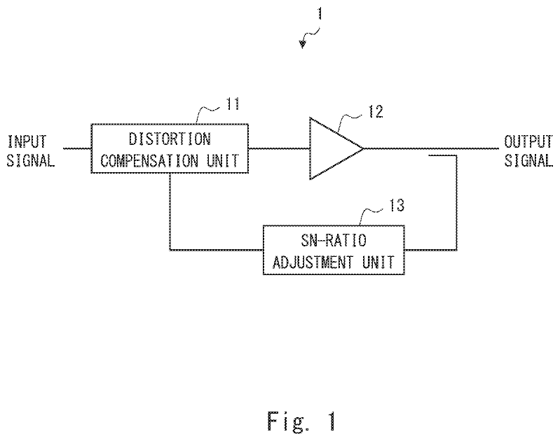

FIG. 1 is a block diagram showing a configuration example of a wireless device 1 according to a first example embodiment.

As shown in FIG. 1, the wireless device 1 includes a distortion compensation unit 11, an amplifier 12, and a signal-to-noise-ratio adjustment unit (SN-ratio adjustment unit) 13. Note that, an SN ratio is an abbreviation for a Signal to Noise ratio.

The distortion compensation unit 11 imparts a distortion compensation component to a radio signal (input signal) input to the wireless device 1 and outputs the radio signal. Note that, the distortion compensation component has an inverse characteristic of a distortion component contained in an output signal of the post-stage amplifier 12. The amplifier 12 amplifies the radio signal to which the distortion compensation component is imparted by the distortion compensation unit 11. The output signal of the amplifier 12 is used as an output signal of the wireless device 1 and is fed back to the distortion compensation unit 11 via a feedback path.

Here, the signal-to-noise-ratio adjustment unit 13 is provided on the feedback path. The signal-to-noise-ratio adjustment unit 13 deteriorates a signal to noise ratio (SN ratio) of the output signal of the amplifier 12 and outputs the output signal as a feedback signal. In other words, the signal-to-noise-ratio adjustment unit 13 increases the noise component in the output signal of the amplifier 12 and outputs the output signal as a feedback signal.

The distortion compensation unit 11 estimates, from the feedback signal, a distortion component contained in the output signal of the amplifier 12 (the nonlinear response characteristic of the amplifier 12), and imparts the distortion compensation component having an inverse characteristic of the estimated distortion component to the radio signal (input signal) input to the wireless device 1. As the result, the distortion component contained in the output signal of the amplifier 12 is cancelled, and the non-linearity of the output signal of the amplifier 12 (that is, the output signal of the wireless device 1) is improved.

Here, the feedback signal after the SN ratio is deteriorated can be regarded as the feedback signal before the SN ratio is deteriorated (that is, the output signal of the amplifier 12) approximately perturbed according to Gaussian distribution. In addition, the deterioration amount of the SN ratio can be considered as the dispersion of Gaussian distribution. Under these conditions, if model estimation using a least-squares method is employed as model estimation (polynomial model estimation) of a distortion component using a polynomial function by the distortion compensation unit 11, the model estimation is equivalent to polynomial model estimation by ridge regression for the output signal of the amplifier 12 whose SN ratio is not deteriorated.

Ridge regression is a method to stably obtain a more valid polynomial model by reducing the complexity of a polynomial model, and a model expected to have a high-performance distortion correction effect can be obtained in polynomial model estimation using the least-squares method by the distortion compensation unit 11. Note that, the polynomial model estimation by the distortion compensation unit 11 is not limited to the model estimation using the least-squares method, and the polynomial model estimation by ridge regression may be already employed, or an estimation method using neural network may be employed. In any case, it is possible to obtain an effect for reducing the complexity of a polynomial model.

Note that, by changing the degree of the deterioration amount of the SN ratio, it is possible to change the coefficient of a regularization term of a cost function in model estimation and to control the complexity of a polynomial model. For example, if the deterioration amount of the SN ratio is too small, highly-accurate model estimation cannot be performed due to the influence of disturbance. Alternatively, if the deterioration amount of the SN ratio is too large, highly-accurate model estimation cannot be performed either due to dominant noise. For these reasons, it is desirable that the SN ratio at which the most effective distortion compensation is obtained according to the assumed output and non-linearity of the amplifier 12 is measured in advance and that the signal-to-noise-ratio adjustment unit 13 adjusts the SN ratio according to the operating state of the amplifier 12. Note that, the feedback signal whose SN ratio is deteriorated by the signal-to-noise-ratio adjustment unit 13 may be controlled to be constant regardless of the output level of the amplifier 12.

In this manner, the wireless device 1 according to the present example embodiment deteriorates, by the signal-to-noise-ratio adjustment unit 13, the SN ratio of the output signal of the amplifier 12 to be fed back to the distortion compensation unit 11. As the result, the wireless device 1 according to the present example embodiment can perform, by the distortion compensation unit 11, highly-accurate model estimation of a distortion component at a similar level to polynomial model estimation by ridge regression. As the result, the wireless device 1 according to the present example embodiment can efficiently reduce the distortion component contained in the output signal of the amplifier 12 to improve the linearity of the output signal (radio signal) of the amplifier 12.

In addition, the wireless device 1 does not need to change the algorithm of digital signal processing to perform highly-accurate polynomial model estimation. For this reason, even if, for example, an application specific integrated circuit (ASIC) for achieving high-speed digital signal processing is mounted, there is no need to remanufacture semiconductors, and the increase in cost can be controlled.

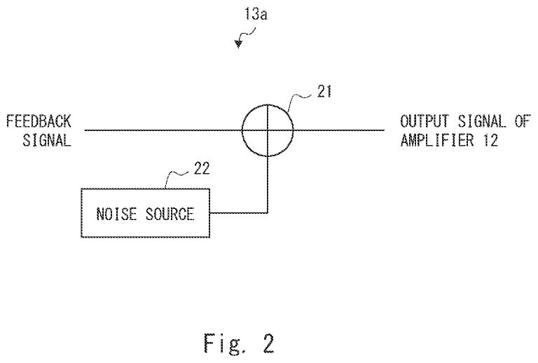

Next, with reference to FIGS. 2 to 5, specific configuration examples of the signal-to-noise-ratio adjustment unit 13 are described.

### (First Specific Configuration Example of Signal-to-Noise-Ratio Adjustment Unit 13)

FIG. 2 is a block diagram showing a first specific configuration example of the signal-to-noise-ratio adjustment unit 13 as a signal-to-noise-ratio adjustment unit 13a.

As shown in FIG. 2, the signal-to-noise-ratio adjustment unit 13a includes a combiner 21 and a noise source 22. The noise source 22 is a source of generating noise. The combiner 21 combines the output signal of the amplifier 12 with the noise generated by the noise source 22 and outputs it as a feedback signal. As the result, the signal-to-noise-ratio adjustment unit 13a can deteriorate the SN ratio of the output signal of the amplifier 12.

### (Second Specific Configuration Example of Signal-to-Noise-Ratio Adjustment Unit 13)

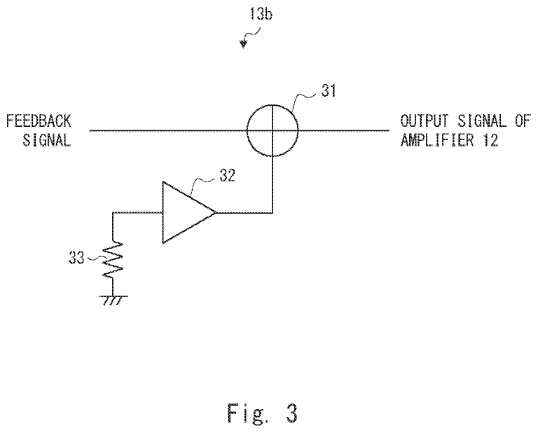

FIG. 3 is a block diagram showing a second specific configuration example of the signal-to-noise-ratio adjustment unit 13 as a signal-to-noise-ratio adjustment unit 13b.

As shown in FIG. 3, the signal-to-noise-ratio adjustment unit 13b includes a combiner 31, a low-noise amplifier 32, and a resistive element 33. The resistive element 33 generates thermal noise. The low-noise amplifier 32 amplifies the thermal noise generated by the resistive element 33. The combiner 31 combines the output signal of the low-noise amplifier 32 with the output signal of the amplifier 12 and outputs it as a feedback signal. As the result, the signal-to-noise-ratio adjustment unit 13b can deteriorate the SN ratio of the output signal of the amplifier 12.

### (Third Specific Configuration Example of Signal-to-Noise-Ratio Adjustment Unit 13)

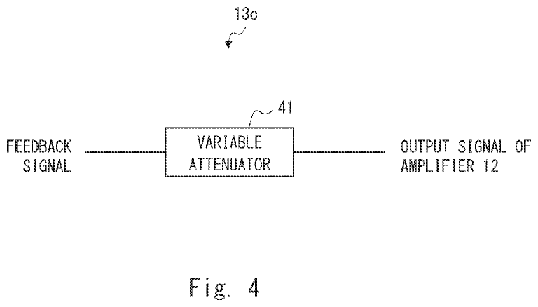

FIG. 4 is a block diagram showing a third specific configuration example of the signal-to-noise-ratio adjustment unit 13 as a signal-to-noise-ratio adjustment unit 13c.

As shown in FIG. 4, the signal-to-noise-ratio adjustment unit 13c includes a variable attenuator 41. The variable attenuator 41 attenuates the level (amplitude) of the output signal of the amplifier 12 to deteriorate the SN ratio of the output signal of the amplifier 12.

### (Fourth Specific Configuration Example of Signal-to-Noise-Ratio Adjustment Unit 13)

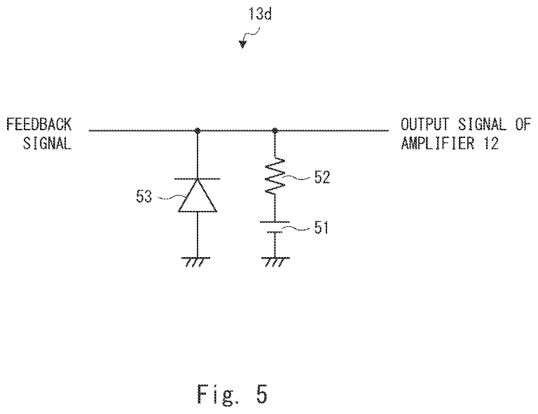

FIG. 5 is a block diagram showing a fourth specific configuration example of the signal-to-noise-ratio adjustment unit 13 as a signal-to-noise-ratio adjustment unit 13d. In the signal-to-noise-ratio adjustment unit 13d, a specific example of the variable attenuator 41 provided to the signal-to-noise-ratio adjustment unit 13c is shown.

As shown in FIG. 5, the signal-to-noise-ratio adjustment unit 13d includes a voltage source 51, a resistive element 52, and a shunt diode 53. The voltage source 51 is provided between the ground and the resistive element 52. The resistive element 52 is provided between the voltage source 51 and the feedback path. The diode 53 has an anode connected to the ground and a cathode connected to the feedback path. The voltage source 51 is configured to change the output voltage.

Here, the signal-to-noise-ratio adjustment unit 13d changes the output voltage of the voltage source 51 to change the voltage to be applied to the diode 53, thereby changing the impedance of the diode 53. As the result, the signal-to-noise-ratio adjustment unit 13d attenuates the level (amplitude) of the output signal of the amplifier 12 to deteriorate the SN ratio of the output signal of the amplifier 12.

Note that, the signal-to-noise-ratio adjustment unit 13 is not limited to the above specific configurations and can be appropriately changed to other configurations that can perform equivalent operation.

### Second Example Embodiment

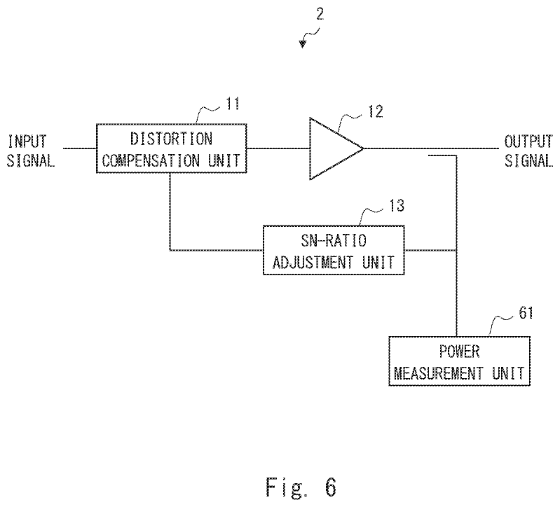

FIG. 6 is a block diagram showing a configuration example of a wireless device 2 according to a second example embodiment.

The wireless device 2 shown in FIG. 6 further includes a power measurement unit 61, compared with the wireless device 1 shown in FIG. 1.

The power measurement unit 61 measures the power of the output signal of an amplifier 12 that is normally operating. A signal-to-noise-ratio adjustment unit 13 adjusts, based on the result of measurement by the power measurement unit 61, the degradation degree of the SN ratio of the output signal of the amplifier 12. As the result, the wireless device 2 can adjust the degradation degree of the SN ratio more accurately than the wireless device 1.

The other configuration of the wireless device 2 is similar to that of the wireless device 1, and the description thereof is omitted.

### Third Example Embodiment

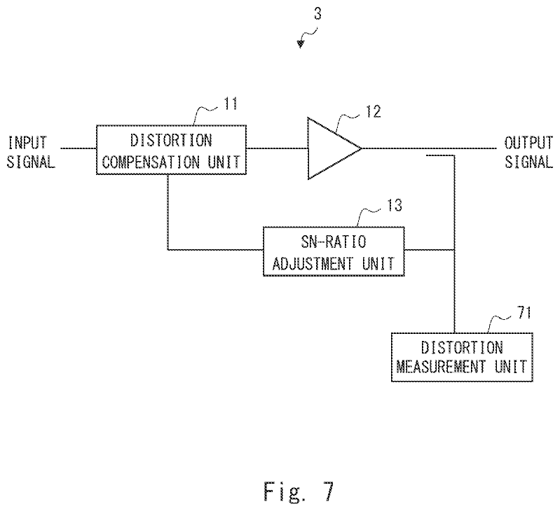

FIG. 7 is a block diagram showing a configuration example of a wireless device 3 according to a third example embodiment.

The wireless device 3 shown in FIG. 7 further includes a distortion measurement unit 71, compared with the wireless device 1 shown in FIG. 1.

The distortion measurement unit 71 measures a distortion component contained in the output signal of an amplifier 12 that is normally operating. A signal-to-noise-ratio adjustment unit 13 adjusts the degradation degree of the SN ratio of the output signal of the amplifier 12 in such a manner as to reduce the distortion component measured by the distortion measurement unit 71 (ideally to be minimum). As the result, the wireless device 3 can perform distortion compensation more stably and adaptively to the influence of disturbance due to time variance or the like than the wireless device 1.

The other configuration of the wireless device 3 is similar to that of the wireless device 1, and the description thereof is omitted. Note that, the wireless device 3 may further includes the power measurement unit 61 and adjust, based on the result of measurement by the power measurement unit 61 in addition to the measurement result by the distortion measurement unit 71, the degradation degree of the SN ratio of the output signal of the amplifier 12.

As described above, the wireless device according to the above first to third example embodiments deteriorate, by the signal-to-noise-ratio adjustment unit 13, the SN ratio of the output signal of the amplifier 12 to be fed back to the distortion compensation unit 11. As the result, the wireless device according to the above first to third example embodiments can perform, by the distortion compensation unit 11, highly-accurate model estimation of a distortion component at a similar level to polynomial model estimation by ridge regression. As the result, the wireless device according to the above first to third example embodiments can efficiently reduce the distortion component contained in the output signal of the amplifier 12 to improve the linearity of the output signal (radio signal) of the amplifier 12.

In addition, the wireless device according to the above first to third example embodiments does not need to change the algorithm of digital signal processing to perform highly-accurate polynomial model estimation. For this reason, even if, for example, an ASIC for achieving high-speed digital signal processing is mounted, there is no need to remanufacture semiconductors, and the increase in cost can be controlled.

The configuration in Japanese Unexamined Patent Application Publication No. 2018-78532 is to attenuate the output signal of the amplifier to be used for feedback to deteriorate the SN ratio. In contrast, the wireless device according to the above first to third example embodiments adds noise to the output signal of the amplifier to be used for feedback to deteriorate the SN ratio. Thus, Japanese Unexamined Patent Application Publication No. 2018-78532 is different from the wireless device according to the above first to third example embodiments in the method for deteriorating the SN ratio. In addition, the wireless device according to the above first to third example embodiments can adjust the SN ratio with the signal level maintained and transmit the feedback signal to a post-stage circuit, and it is possible to easily maintain a sufficient input level for a circuit assumed to be the post-stage circuit, such as a digital-analog converter (AD converter) or a power detector. As the result, an input-level adjustment circuit for an AD converter or a power detector can be kept simple, and the feedback signal can be handled with a higher quality.

As described above, the example embodiments of the present disclosure have been described in detail with reference to the drawings, but specific configurations are not limited to the above, and the design and the like can be variously changed without departing from the scope of the present disclosure.

The present disclosure has been described as a hardware configuration in the above example embodiments, but the present disclosure is not limited thereto. The present disclosure can be also achieved by causing a central processing unit (CPU) to execute a computer program for control processing by the wireless devices 1 to 3.

In addition, the above program includes instructions (or software codes) that, when loaded into a computer, cause the computer to perform one or more functions described in the example embodiments. The program may be stored in non-transitory computer readable medium or tangible storage medium. The non-transitory computer readable medium or the tangible storage medium includes any type of tangible storage medium. The non-transitory computer readable medium includes, for example, a random access memory (RAM), a read-only memory (ROM), a flash memory, a solid-state drive (SSD), or other memory techniques, a CD-ROM, a digital versatile disc (DVD), a Blu-ray (registered trademark) disc, or other optical disc storage devices, a magnetic cassette, a magnetic tape, a magnetic disc storage, or other magnetic storage devices, but are not limited thereto. The program may be transmitted on transitory computer readable medium or communication medium. The transitory computer readable medium or communication medium include, for example, electrical, optical, acoustic, or other forms of propagated signals, but are not limited thereto.

According to the above example embodiments, it is possible to provide a wireless device, a control method thereof, and a control program capable of improving the linearity of a radio signal.

The first to third embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. A wireless device comprising:
a distortion compensation unit configured to impart a distortion compensation component to a radio signal and output the radio signal;
an amplifier configured to amplify the radio signal to which the distortion compensation component is imparted by the distortion compensation unit; and
a signal-to-noise-ratio adjustment unit configured to deteriorate a signal to noise ratio of an output signal of the amplifier and output the output signal as a feedback signal,
wherein the distortion compensation unit is configured to estimate, from the feedback signal, a distortion component contained in the output signal of the amplifier and impart the distortion compensation component having an inverse characteristic of the estimated distortion component to the radio signal.

2. The wireless device according to claim 1, wherein
the signal-to-noise-ratio adjustment unit includes:
a noise source configured to generate noise; and
a combiner configured to combine the noise generated by the noise source with the output signal of the amplifier.

3. The wireless device according to claim 1, wherein
the signal-to-noise-ratio adjustment unit includes:
a resistive element configured to generate thermal noise;
a low-noise amplifier configured to amplify the thermal noise generated by the resistive element; and
a combiner configured to combine an output signal of the low-noise amplifier with the output signal of the amplifier.

4. The wireless device according to claim 1 further comprising a power measurement unit configured to measure power of the output signal of the amplifier,
wherein the signal-to-noise-ratio adjustment unit is configured to adjust, based on a result of measurement by the power measurement unit, a degradation degree of the signal to noise ratio of the output signal of the amplifier.

5. The wireless device according to claim 1 further comprising a distortion measurement unit configured to measure the distortion component contained in the output signal of the amplifier,
wherein the signal-to-noise-ratio adjustment unit is configured to adjust, based on the result of measurement by the distortion measurement unit, the degradation degree of the signal to noise ratio of the output signal of the amplifier.

6. A control method of a wireless device, the method comprising:
imparting a distortion compensation component to a radio signal and outputting the radio signal;
amplifying, by an amplifier, the radio signal to which the distortion compensation component is imparted; and
deteriorating a signal to noise ratio of an output signal of the amplifier and outputting the output signal as a feedback signal,
wherein in the imparting of the distortion compensation component to the radio signal and the outputting of the radio signal, a distortion component contained in the output signal of the amplifier is estimated from the feedback signal and the distortion compensation component having an inverse characteristic of the estimated distortion component is imparted to the radio signal.

7. A non-transitory computer readable medium storing a control program causing a computer to execute:
a distortion compensation process of imparting a distortion compensation component to a radio signal and outputting the radio signal;
an amplification process of amplifying, by an amplifier, the radio signal to which the distortion compensation component is imparted; and
a signal-to-noise-ratio adjustment process of deteriorating a signal to noise ratio of an output signal of the amplifier and outputting the output signal as a feedback signal,
wherein the distortion compensation process includes estimating, from the feedback signal, a distortion component contained in the output signal of the amplifier and imparting the distortion compensation component having an inverse characteristic of the estimated distortion component to the radio signal.
